(19) United States
(12) Patent Application Publication
(10) Pub. No.: US 2022/0040797 A1
(43) Pub. Date: Feb. 10, 2022

(54) LASER CUTTING METHOD

(71) Applicant: BYSTRONIC LASER AG, Niederönz (CH)

(72) Inventor: Michael Berger, Bern (CH)

(21) Appl. No.: 17/434,985

(22) PCT Filed: Mar. 20, 2020
(86) PCT No.: PCT/EP2020/057761

§ 371 Date: Aug. 30, 2021

(30) Foreign Application Priority Data
Mar. 22, 2019 (EP) 19164623.1

(51) Int. Cl. B23K 26/38; B23K 26/144; B23K 26/18; B23K 26/40

(52) U.S. Cl. CPC B23K 26/38; B23K 26/144; B23K 2103/04; B23K 26/40; B23K 26/18

(57) ABSTRACT

The present invention concerns a laser cutting method, the method comprising the steps of providing a workpiece of a metallic workpiece material, directing a laser beam onto a surface of the workpiece and moving the laser beam relative to the metal workpiece to create a laser cut. According to an aspect of the invention, a supplemental material is provided at the position of incidence. In this, the supplemental material is capable of reducing the melting temperature of the workpiece material when combined with the workpiece material. For example, the workpiece material and the supplemental material may together form a eutectic system.

### FIELD OF THE INVENTION

The invention is in the field of laser cutting of metal workpieces.

### BACKGROUND OF THE INVENTION

In laser cutting of metal workpieces, a directed laser beam moves relative to the metal workpiece to locally melt the metal material at the position of incidence of the laser beam on the workpiece. This produces a laser cut. Modern laser cutting machines also direct a gas flow onto the position of incidence of the laser beam. The gas flow may assist the removal (“blowing”) of molten metal material and/or, if it contains molecular oxygen, be involved in a chemical reaction (“burning”). Both, the removal and, if applicable, the chemical reaction, help reducing the required laser power.

There is an ongoing need to optimize the laser cutting process.

### SUMMARY OF THE INVENTION

It is an object of the present invention to provide a laser cutting method that at least for some metallic workpiece materials is improved compared to the prior art.

The present invention concerns a laser cutting method, the method comprising the steps of providing a workpiece of a metallic workpiece material, directing a laser beam onto a surface of the workpiece to locally make the workpiece material flowable and moving the laser beam relative to the metal workpiece to create a laser cut. According to an aspect of the invention, a supplemental material is provided at the position of incidence. In this, the supplemental material is capable of reducing a melting temperature of the workpiece material when combined with the workpiece material.

By this approach, the required energy input may be reduced. This is by itself an advantage in that the power consumption of the laser cutting machine used is lower compared to the prior art. Also, there may be further advantages such as reduced damages due to burning effects, the capability of cutting through thicker workpieces compared to the prior art, etc.

The method therefore may comprise determining a required laser energy input per surface area to be made flowable or per cut length for the given workpiece without the supplemental material (for which determination in many cases an abundance of data will be available, for example in the programming tools of the respective machines), of calculating a reduced required laser energy input (per surface area to be made flowable or per cut length) and of applying the reduced required laser energy input.

The method, therefore, also may in addition or as an alternative comprise the step of using a laser cutting machine controlling software or laser cutting preparation software, which software calculates a required laser energy input (per surface area to be made flowable or per cut length) from parameters of the workpiece (material, thickness, etc.) and possibly other inputs (such desired laser beam properties, cutting gas properties etc.). This calculated required laser energy input is then used in controlling the cutting process, i.e. in the step of directing the laser beam onto the surface, a laser power, a laser beam diameter and a velocity of the movement of the laser beam relative to the metal workpiece are adapted to each other for this laser energy input per surface area or cut length to be achieved. Due to the approach according to the invention, because this laser energy input per surface area or cut length is smaller than in the prior art, the movement velocity may be enhanced, the laser power may be reduced, or workpieces otherwise not available for being laser cut by the particular machine may be subject to laser cutting.

In accordance with embodiments of the invention, such calculation software uses information on the supplemental material as a further input in this calculation, wherein the result of the calculation depends on this further input. Especially, the result of the calculation may yield a smaller required laser energy input in the presence of the supplemental material than if the supplemental material was not present.

In embodiments, a quantity of the supplemental material (such as a thickness of the coating layer or a flow of the gas, depending on how the supplemental material is supplied, see below) belongs to this input quantity.

In embodiments, the calculation takes into account the reduced melting temperature (or, equivalent, the reduced energy input per mass or volume unit required for making the workpiece material flowable), the reduced melting temperature being a calculated quantity or a quantity stored in memory, for example in a look-up table.

In a first group of embodiments, the supplemental material is provided as a coating applied to the workpiece prior to directing the laser beam onto the surface.

For example, such coating may be of a material that has a comparably large laser radiation absorption (larger absorptivity/absorptance). For example, the absorptivity may be higher than the absorptivity of the workpiece material (on its surface) itself. Thereby, the supplemental material has an additional effect, namely the effect of increasing the absorption and thereby further increasing the efficiency.

Especially, but not only, in embodiments in which a sufficiently high absorptivity is not a material property of the supplemental material, the structure of the coating may be chosen such that radiation reflections are reduced compared to a plane surface. For example, in embodiments, the coating may be applied such as to form a nanostructured surface (nanotextured surface). According techniques are known in the art. In a special embodiment, the coating surface may correspond to a fractal surface.

A coating may be applied covering a large area of the one surface of the workpiece onto which the laser beam is directed. Alternatively, the coating may be applied selectively to only cover the track to be followed by the laser. For example, a cutting plan may be directly printed onto the workpiece. In this, the supplemental material may form part of a suitable ink containing the supplemental material. The coating may then be plotted onto the surface of the workpiece.

A thickness of the coating is chosen to be sufficient for there being a sufficient quantity of the coating material for achieving the desired reduction of the melting temperature. For example, for the Carbon-Iron-System and taking into account the fact that the density of steel is higher than the density of graphite by about a factor 4, for achieving a Carbon content of 4%, the thickness of the graphite layer would have to be chosen to be at least about 16% of the thickness of the workpiece if the workpiece did not contain any Carbon itself. In practice, it is not necessary to have a Carbon content of as much as 4% for the approach according to the invention to have any effect, and it the workpiece itself may already contain some carbon. Nevertheless, it may be advantageous if the thickness of the coating is substantial and amounts to for example at least 0.5% or at least 1% or at least 2% or at least 3, 4, 5, or 8% of the thickness of the workpiece. The thickness of the coating may hence in embodiments especially be different from a mere color coat and may be more than 0.15 mm, more than 0.2 mm or 0.25 mm, or more than 0.5 mm. In addition or as an alternative, especially if it is thinner than these values, it may optionally be combined with a gas jet according to the second group of embodiments, as described hereinafter.

In a second group of embodiments, the supplemental material is provided as a gas, especially as a constituent of a gas jet directed onto the position of incidence of the laser beam.

Such a gas jet is an optional feature of all embodiments of the invention, including embodiments of the first group. Thus, generally, in addition to the laser beam, also a gas jet may be directed onto the position of incidence of the laser beam.

The supplemental material be chosen such as to form a eutectic system together with the workpiece material. In a eutectic system, there is a particular composition (eutectic composition) of the constituents at which the melting point is lower than the melting point of the constituents. Thus, a eutectic system is an example of a system in which one material (the supplemental material in the example of the present invention) is capable of reducing a melting temperature of the other material (the workpiece material in the present example). If the system has a composition deviating from the eutectic composition, the system will, when the temperature is raised above the melting temperature of the eutectic composition, form a saturated solution being a heterogeneous mixture of molten alloy material and of solid bodies of at least one of the constituents. Such mixture is flowable (i.e., capable of flowing) if the proportion of molten alloy material is sufficiently high.

It is an insight of the present invention that, especially in the presence of a gas jet that blows away sufficiently flowable material, it is not necessary that the workpiece material in the cut needs to be completely liquefied, i.e. not all workpiece material and/or not all supplemental material needs to be molten. Rather, a heterogeneous mixture of locally molten material and solid particles can be blown out of the cut also. Therefore, for example in embodiments with a eutectic system there is no need for the ratio between the workpiece material and the supplemental material to be precisely defined for the approach of the invention to work. Rather, it is sufficient if they may form the eutectic system, whereby heating to the solidus temperature, corresponding to the melting temperature of the eutectic composition, or to a temperature slightly above is sufficient. This solidus temperature will be below the melting temperature of the workpiece material.

An example of a eutectic system suitable for the present invention is the Iron-carbon system. Thus, for workpieces of steel, carbon is a suitable supplemental material. Carbon may be provided by way of a coating of any coating composition containing elemental carbon, such as a coating of graphite or an organic coating, including a coating of a carbon-based polymer. Examples of suitable coatings include carbon containing inks or polymers, especially polymers with a constituent that absorbs the laser radiation. In embodiments of the second group, the carbon may be provided as carbon containing gas, such as carbon dioxide or methane, or possibly, in a suitable (safe) environment, carbon monoxide.

Further examples include Eutectic systems including other prevalent workpiece materials, such as the copper-silicon system (with silicone as a possible silicon containing coating material for a copper workpiece), the copper-tin-system, the copper-zinc-system, the aluminum-silicon system and others. Also workpiece materials that themselves are alloys may be susceptible to adding a further material to form a ternary eutectic system.

Generally, the invention may apply to configurations in which the workpiece is provided as a sheet material, i.e. is plate-shaped, with the laser incident, for example perpendicularly, on a large plate surface. It is, however, not ruled out that the cutting method is applied to tubular workpieces in/on a tube laser cutting machine or to workpieces with more complex geometries.

A machine for carrying out the method described herein may be a laser cutting machine as known in the art. The machine may for example be of the ‘flying beam’ type.

In contrast to prior art laser cutting machines, however, the machine may for example be programmed for supplemental material parameters to be input and for cutting parameters to be adapted based on this input. For example, the laser radiation may, in presence of the supplemental material, be reduced compared to the situation without the supplemental material, and/or a cutting velocity (i.e. a velocity by which the laser beam is moved relative to the workpiece) may be enhanced.

The invention moreover concerns a laser cutting machine system, equipped for carrying out the method as described and defined in this text. The system comprises a laser cutting machine, for example as specified above, with a laser cutting head for emitting a laser beam. The machine further comprises a storage for holding a suitable supplemental material, for example a material capable of forming a eutectic system with a common workpiece material such as with steel, copper and or aluminum.

Such storage may comprise a foil coil—if the supplemental material is to be a coating over a large surface—or an ink tank, the latter especially for applying the coating selectively. In addition or as an alternative, the storage may comprise a gas container, such as a gas bottle filled with CO2 or with methane, etc.

The laser cutting machine system may further comprise a printing device for applying the supplemental material if it is contained in an ink, the printing device especially being equipped for applying the supplemental material in a selective manner, for example in accordance with a cutting plan stored in a memory of the laser cutting machine.

Moreover, the system may further comprise information, for example stored in a memory of the laser cutting machine or other component of the system, which information enables a user to use and apply an appropriate supplemental material in an appropriate amount and/or which information is used by the laser cutting machine for setting the cutting parameters prior to the cutting process, for example as specified hereinbefore, taking into account the reduced melting temperature.

### BRIEF DESCRIPTION OF THE DRAWINGS

Hereinafter, embodiments of the present invention are described in more detail referring to drawings. The drawings are schematic and not to scale. In the drawings, same reference numbers refer to same or similar components. They show:

FIG. 1: A generic phase diagram of a eutectic system;

FIG. 2 A laser cutting machine;

FIG. 3: A laser cutting head and a workpiece in an embodiment of the first group;

FIG. 4: A laser cutting head and a workpiece in an embodiment of the second group; and

FIG. 5 A phase diagram of the iron-carbon system.

### DESCRIPTION OF THE PREFERRED EMBODIMENTS

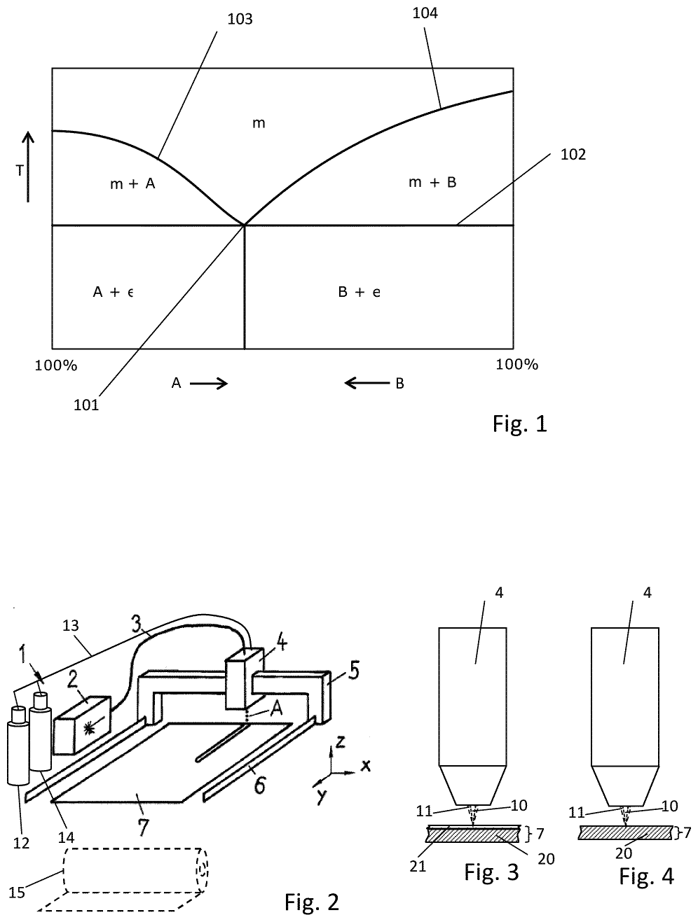

FIG. 1 depicts a schematic phase diagram of a metallic binary eutectic system of the components A and B of which both or one may be metallic. The eutectic point 101 defines a eutectic composition (defined ratio between A and B) and a melting point of the eutectic composition, and defines a solidus line 102 corresponding to the melting point of the eutectic composition. At temperatures below this solidus line temperature, the system will form solid mixtures of A and the eutectic (A+e) or of B and the eutectic (B+e) if the composition deviates from the eutectic composition. Above the solidus line, but below the respective liquidus line 103, 104, the system if deviating from the eutectic composition will form supersaturated solutions, namely a melt plus solid A (m+A), or a melt plus solid B (m+B), respectively, whereas above the respective liquidus line 103, 104 the system will just form a melt (unsaturated solution).

From this diagram it becomes clear that for compositions deviating from pure or nearly pure A or B, it is sufficient to heat to the solidus temperature (temperature defined by the solidus line 102 corresponding to the melting point of the eutectic) to melt or partially melt the composition and thereby make the composition capable of flowing (flowable).

FIG. 2 shows an example of a laser cutting machine 1. The machine comprise a laser radiation source 2, a radiation guide 3, a laser cutting head 4, and a laser head 4 moving mechanism comprising a frame 5 relative to which the laser cutting head 4 is movable, relative to a working table (not shown) supporting the workpiece 7, in x direction and which itself is movable, for example on a pair or rails 6, in y direction. Other configurations with movable laser heads (“flying optics” configurations) and/or with a movable workpiece are possible and known in the art.

A common cutting gas such as N₂ is stocked in a gas container 12 and is fed via a gas line 13 to the cutting head 4. The cutting head 4 directs a focused laser beam A onto the workpiece 7 to generate, when the laser head is moved relative to the workpiece 7 a cut therein. In addition to the laser beam, the cutting head will also direct a gas jet (not shown in FIG. 2) onto the workpiece. The gas jet in a laser cutting process may have several functions. Firstly, it blows away any molten material in the cut. Secondly, by the gas composition being well-known it ensures reproducible conditions. The most commonly used gas jet is a gas jet of N₂. Alternatively, gas jets containing molecular oxygen for a burning process in the workpiece are also common.

FIG. 3 illustrates the method according to the first group of embodiments. The workpiece 7 in addition to the workpiece material 20 is provided with a coating 21 of a coating material. The coating material contains, and for example even consists of, a supplemental material. The material of the workpiece 7 and the supplemental material together form part of a two or more component eutectic system, such as of the iron-carbon system the Cu—Sn system, the Cu—Zn system or any other suitable system. The laser head emits, in addition to the laser beam 10, a gas jet 11 of for example a common cutting gas such as N₂. The laser beam will initiate a melting and mixing process, initially at the interface between the workpiece material 20 and the coating 21, whereby the temperature at which the material becomes flowable (by at least a portion thereof being molten) is reduced to the melting temperature of the eutectic or near eutectic. This will result in a cut through the material at an energy input that is reduced compared to the prior art.

In this, the coating material may be applied to the workpiece only locally at the cutting line, e.g. by printing. The coating material may alternatively be applied to the whole surface of a workpiece by plotting or in form of a foil, e.g. from a coil 15 (FIG. 2), covering the surface of the workpiece.

For example if the coating material is a foil, for example containing carbon, it may be applied to the workpieces (especially metal sheets) when they are being moved into the cutting machine or even before e.g. after production of the workpiece and before the workpiece is fed into the laser cutting machine.

FIG. 4 illustrates the method according to the second group of embodiments. The workpiece 7 does not necessarily comprise a coating but instead the gas jet comprises a supplemental material capable of forming a eutectic system together with the workpiece material 20. For example if the workpiece material is steel, the gas jet may comprise carbon dioxide as the supplemental material which may be delivered from a gas container 14 (FIG. 2).

In both groups of embodiments, the sequence of method steps may be summarized as follows: A metallic workpiece and a supplemental material are provided. Also, the laser cutting machine may be appropriately programmed. In embodiments in which the supplemental material is provided as a coating, the coating is applied to the workpiece material. The laser beam is then, in presence of the supplemental material, directed onto a surface of the workpiece to locally make the workpiece material flowable where the laser beam impinges on the workpiece. A gas jet—which in embodiments of the second group may contain the supplemental material or a portion thereof—is used to blow away flowable material. During these steps of using the laser beam to locally make material flowable and blowing flowable material away, the laser beam is moved relative to the workpiece to generate a laser cut.

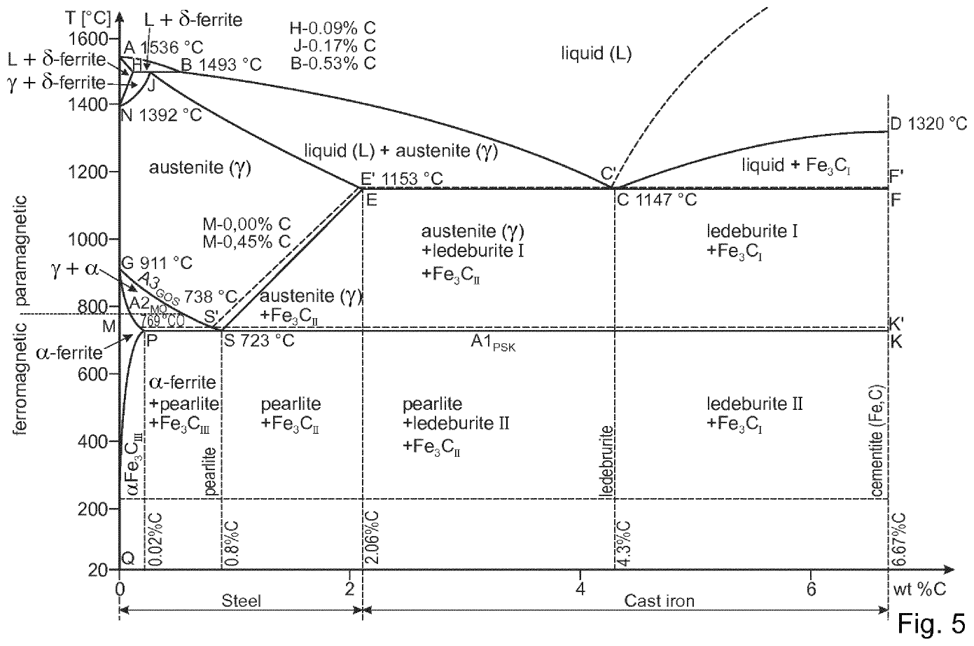

FIG. 5 is an excerpt of the online encyclopedia Wikipedia (https://en.wikipedia.org/wiki/File:Iron_carbon_phase_diagram.svg, retrieved on 11 Mar. 2019) and reproduces the phase diagram of the iron-carbon-system. It becomes clear that at a carbon content of 4.3% a eutectic is formed, having a melting point of 1147° C., compared to 1536° C. of iron. Hence, adding a sufficient amount of carbon—by way of a coating or stemming from a gas—will lead to a substantial reduction of the temperature required for making the iron-based. Steel-based workpiece materials will generally already include some elemental carbon (and may for example comprise other alloy components). Thus, the amount of carbon needed for the flowable phase at a temperature above 1147° C. and a carbon content above 2.06% to exist may depend on the circumstances.

In FIG. 5, the dashed line shows the stable Fe/Carbon phase.

1-16. (canceled)

17. A laser cutting method, the method comprising the steps of:
Providing a workpiece of a metallic workpiece material, and
Directing a laser beam onto a surface of the workpiece to locally make the workpiece material flowable at a position of incidence, and moving the laser beam relative to the metal workpiece to create a laser cut,
the method comprising the further step of
Providing a supplemental material at the position of incidence, the supplemental material capable of reducing a melting temperature of the workpiece material when combined with the workpiece material;
Determining a required laser energy input per surface area to be made flowable or per cut length for the given workpiece without the supplemental material,
Calculating a reduced required laser energy input using information on the supplemental material as a input and applying the reduced required laser energy input,
characterized in that
the step of providing the supplemental material comprises providing at least a portion of the supplemental material as a gas supplied to the position of incidence.

18. The method according to claim 1, further comprising directing a gas jet onto the position of incidence.

19. The method according to claim 1, wherein the step of providing the supplemental material further comprises providing a portion of the supplemental material as a coating of the workpiece material, the coating being applied prior to the step of directing the laser beam onto the surface.

20. The method according to claim 3, wherein the coating has a higher absorptivity for the laser radiation than a surface of the workpiece material.

21. The method according to claim 3, wherein the coating covers a surface of the workpiece material facing a direction from which the laser beam is incident.

22. The method according to claim 3, wherein applying the coating comprises applying the coating selectively only at positions where subsequently the laser cut is created.

23. The method according to claim 1, wherein the supplemental material contains elemental carbon.

24. The method according to claim 1, wherein the workpiece material and the supplemental material together form part in a eutectic system.

25. The method according to claim 1, wherein the workpiece material is steel.

26. The method according to claim 1, wherein the workpiece is plate-shaped, and the laser beam perpendicular is perpendicular to a plate surface of the workpiece.

27. The method according to claim 1, wherein at the position of incidence, a heterogeneous mixture of molten material that includes the workpiece material and the supplemental material, and of solid particles is created removed to create the cut.

28. A laser cutting machine system, the laser cutting machine comprising a laser cutting head for emitting the laser beam (A) and for emitting a gas jet comprising a cutting gas and a supplemental material, a moving mechanism for moving the laser cutting head relative to the workpiece for creating the laser cut, a cutting gas container for storing the cutting gas, and a supplemental gas container for storing the supplemental material, the machine being programmed for a property of the supplemental material being input as supplemental material parameter and for adapting the laser energy input on the workpiece based on the supplemental material parameter, the laser cutting machine system being comprising a laser cutting machine controlling software or laser cutting preparation software, which software is configured to calculate a required laser energy input per surface area to be made flowable or per cut length for the given workpiece without the supplemental material, and to calculate a reduced required laser energy input using information on the supplemental material as a input, the laser cutting machine system being configured to apply the reduced required laser energy input, the laser cutting machine being quipped to carry out the method according to any one of the previous claims.
